(19) United States
(12) Patent Application Publication
(10) Pub. No.: US 2026/0336082 A1
(43) Pub. Date: Oct. 29, 2026

(54) ACCESSORY UNIT AND NAIL GUN HAVING THE SAME

(71) Applicant: BASSO INDUSTRY CORP., Taichung (TW)

(72) Inventors: Guey-Horng LIOU, Taichung (TW); An-Gi LIU, Taichung (TW)

(73) Assignee: BASSO INDUSTRY CORP., Taichung (TW)

(21) Appl. No.: 19/657,801

(22) Filed: Apr. 24, 2026

(30) Foreign Application Priority Data
Apr. 29, 2025 (TW) 114116142

(51) Int. Cl. B25C 1/18

(52) U.S. Cl. CPC B25C 1/188; B25C 1/184

(57) ABSTRACT

An accessory unit is adapted for a nail gun. The accessory unit includes a base seat and a movement member. The base seat has a first couple portion and a block portion. The movement member extends through the base seat, is movable relative to the base seat along an axis, and has a second couple portion.

### CROSS-REFERENCE TO RELATED APPLICATION

This application claims priority to Taiwanese Invention Patent Application No. 114116142, filed on Apr. 29, 2025, the entire disclosure of which is incorporated by reference herein.

### FIELD

The disclosure relates to an accessory unit, and more particularly to a nail gun having an accessory unit.

### BACKGROUND

Referring to FIG. 1, a conventional fastening tool 1 disclosed in U.S. Patent No. US10252406B2 includes a case 11, a bearing part 12 that is connected to the case 11, a nail-striking device 13 that is mounted to the case 11 and that is adapted for striking a nail, and a support frame 14 that is removably mounted to the bearing part 12. When a magazine (not shown) is selected to be mounted to the bearing part 12, the magazine is operable to supply fasteners (not shown) automatically, and to convert the conventional fastening tool 1 into a continuous firing mode. When the support frame 14 is selected to be mounted to the bearing part 12, the conventional fastening tool 1 is converted into a single firing mode, and a user has to load the conventional fastening tool 1 with the fasteners manually.

However, because the support frame 14 corresponds in shape and position to the bearing part 12, an overall structure of a combination of the support frame 14 and the bearing part 12 is, as a structure of the bearing part 12, extremely long, which makes the conventional fastening tool 1 bulky, difficult to store, and costly.

### SUMMARY

Therefore, an object of the disclosure is to provide an accessory unit that can alleviate at least one of the drawbacks of the prior art.

According to the disclosure, the accessory unit is adapted for a nail gun, and includes a base seat and a movement member. The base seat has a first couple portion and a block portion. The movement member extends through the base seat, is movable relative to the base seat along an axis, and has a second couple portion.

Another object of the disclosure is to provide a nail gun that can alleviate at least one of the drawbacks of the prior art.

According to the disclosure, the nail gun is adapted for striking a nail. The nail gun includes a casing unit, a strike unit, a muzzle unit, and the accessory unit as mentioned above. The strike unit is mounted to the casing unit, and includes a strike member that is movable in a nail-striking direction and that is adapted for striking the nail. The muzzle unit is connected to the strike unit, and has a nail channel, an opening, a first engagement portion, and a second engagement portion. The nail channel is adapted for accommodating the nail, and extends in the nail-striking direction. The opening spatially communicates with the nail channel and an external environment. The first engagement portion is adjacent to one side of the opening. The second engagement portion is adjacent to another side of the opening, and is spaced apart from the first engagement portion in the nail-striking direction. The accessory unit is removably connected to the muzzle unit. The first couple portion of the base seat of the accessory unit is coupled to the first engagement portion when the accessory unit is connected to the muzzle unit. The second couple portion of the movement member of the accessory unit is coupled to the second engagement portion when the accessory unit is connected to the muzzle unit. The second couple portion is opposite to the first couple portion. The block portion of the base seat of the accessory unit extends into the opening when the accessory unit is connected to the muzzle unit. The block portion is located between the first couple portion and the second couple portion.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly sectional view of a conventional fastening tool disclosed in U.S. Patent No. US10252406B2.

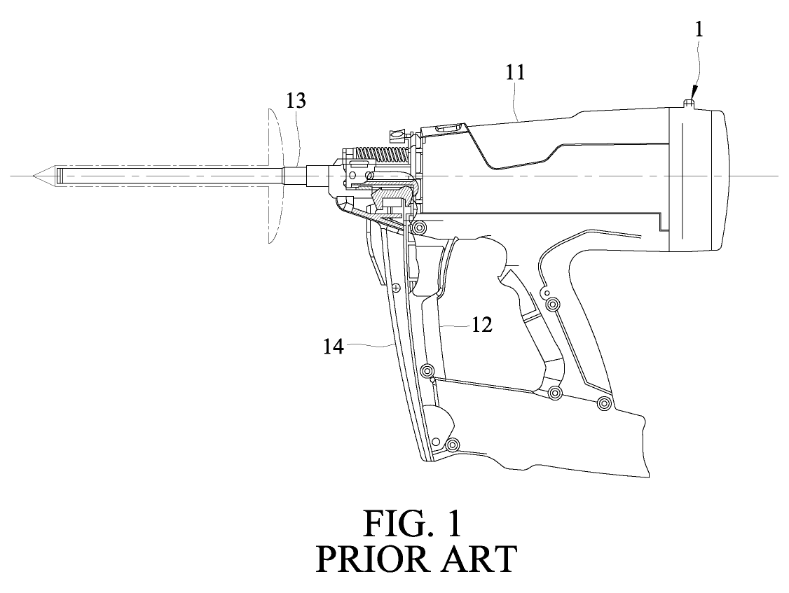

FIG. 2 is a sectional view of an embodiment of a nail gun according to the disclosure.

FIG. 3 is a sectional view similar to FIG. 2, but illustrating that a magazine unit of the embodiment abuts against an installation portion of the embodiment.

FIG. 4 is a partly exploded perspective view of an accessory unit of the embodiment.

FIG. 5 is a perspective view of the accessory unit.

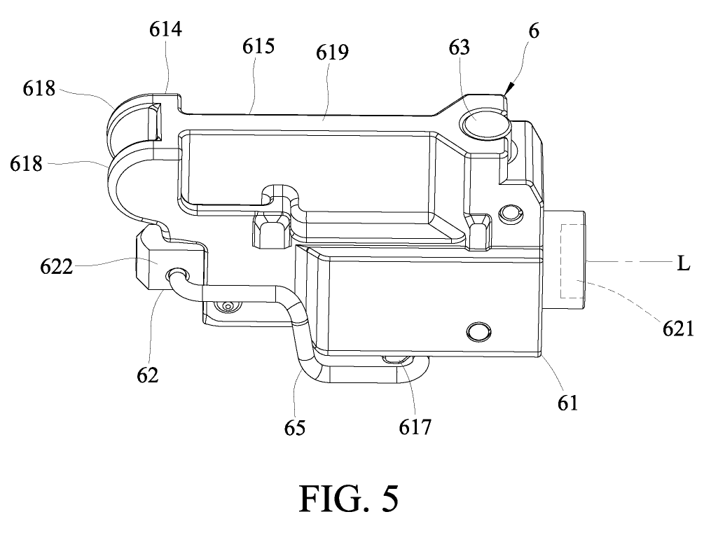

FIG. 6 is a fragmentary sectional view illustrating that a first couple portion of the embodiment is coupled to a first engagement portion of the embodiment.

FIG. 7 is a fragmentary sectional view similar to FIG. 6, but illustrating that a movement member of the embodiment is pushed by an engagement member of the embodiment.

FIG. 8 is a fragmentary sectional view similar to FIG. 7, but illustrating that a second couple portion of the embodiment is coupled to a second engagement portion of the embodiment.

FIG. 9 is a fragmentary sectional view similar to FIG. 6, but illustrating that the movement member is urged to move by a pull member of the embodiment when the pull member is pulled.

FIG. 10 is a fragmentary sectional view similar to FIG. 8, but illustrating a modification of the accessory unit.

FIG. 11 is a fragmentary sectional view similar to FIG. 10, but illustrating that a limitation member of the modification of the accessory unit is separated from a limitation portion of the modification of the accessory unit.

FIG. 12 is a sectional view illustrating another modification of the accessory unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

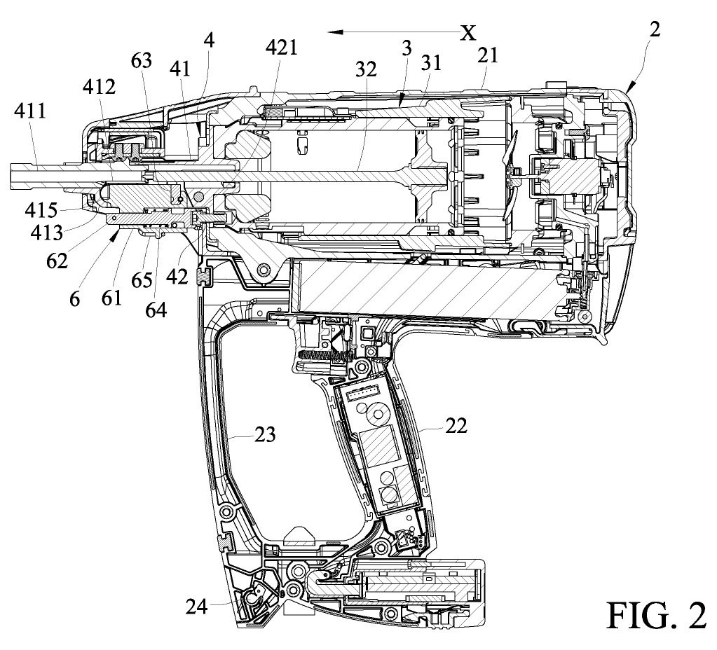

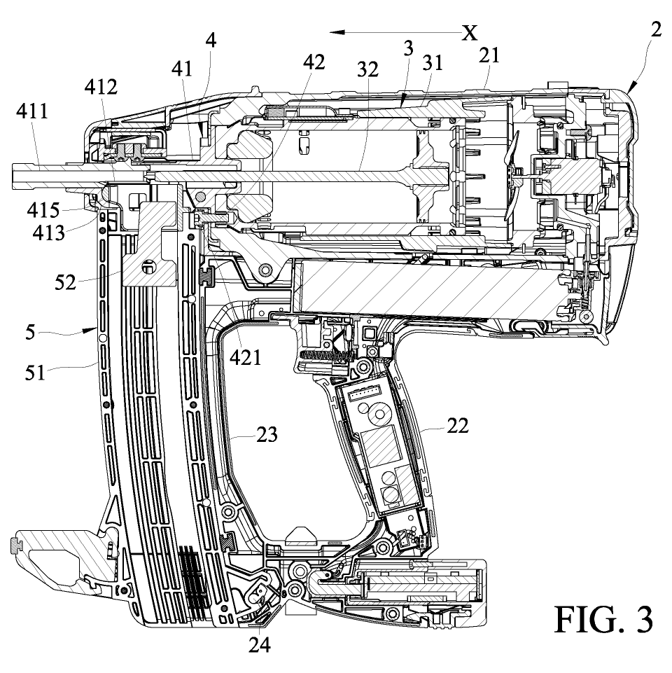

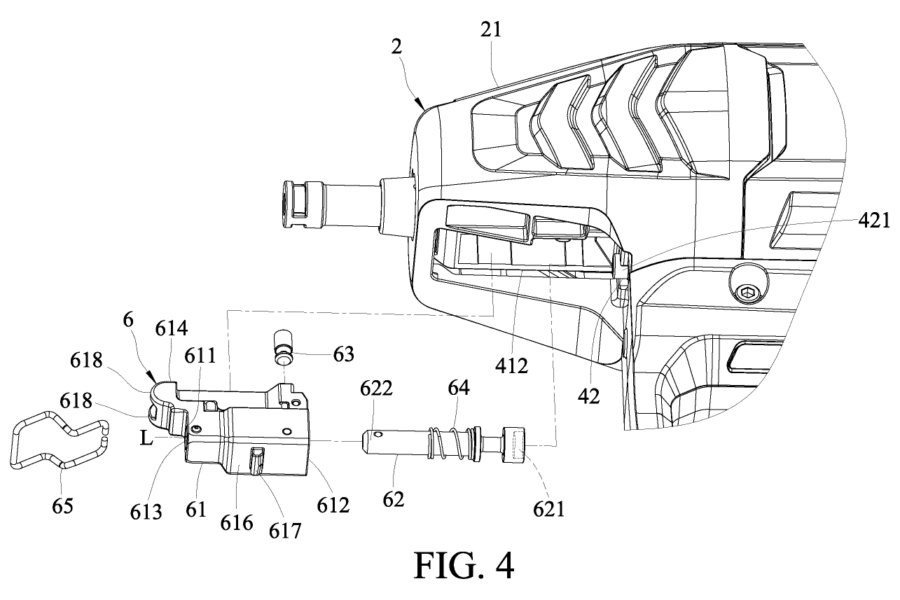

Referring to FIGS. 2 to 4, an embodiment of a nail gun according to the present disclosure is adapted for striking a nail, and includes a casing unit 2, a strike unit 3, a muzzle unit 4, a magazine unit 5, and an accessory unit 6.

The casing unit 2 has a main body portion 21, a grip portion 22, an installation portion 23, and an interconnection portion 24. The main body portion 21 extends in a nail-striking direction (X). The grip portion 22 is connected to the main body portion 21, and cooperates with the main body portion 21 to define an included angle therebetween. The installation portion 23 is connected to the main body portion 21, and is spaced apart from the grip portion 22 in the nail-striking direction (X). The interconnection portion 24 is adjacent to one end of the installation portion 23 that is distal to the main body portion 21, and is connected to the grip portion 22.

In this embodiment, the strike unit 3 is mounted to the main body portion 21 of the casing unit 2, and includes a cylinder 31 and a strike member 32. The strike member 32 extends from the cylinder 31 into the muzzle unit 4, and is movable relative to the cylinder 31 and the muzzle unit 4. The strike member 32 is adapted for striking the nail, and is able to be powered by fuel gas to move in the nail-striking direction (X).

It is noted that the strike unit 3 may not be limited to using the power that is supplied by the fuel gas for a nail-striking operation. In some embodiments, air pressure or electric power may serve as a power source that the strike unit 3 uses for the nail-striking operation.

At least a portion of the muzzle unit 4 is mounted to the main body portion 21 of the casing unit 2 and is connected to the cylinder 31 of the strike unit 3. The muzzle unit 4 includes a muzzle body 41, and an engagement member 42 that is connected to the muzzle body 41.

The muzzle body 41 has a nail channel 411, an opening 412, and a first engagement portion 413. The nail channel 411 extends in the nail-striking direction (X). The opening 412 spatially communicates with the nail channel 411 and an external environment. The first engagement portion 413 is adjacent to and formed at one side of the opening 412 that is distal to the installation portion 23 of the casing unit 2. The nail channel 411 is adapted for accommodating the nail. A portion of the strike member 32 extends into the nail channel 411. In this embodiment, the first engagement portion 413 is configured to be a recess, and has a curved surface 415.

The engagement member 42 is connected to the muzzle body 41 in the nail-striking direction (X), and has a second engagement portion 421. The second engagement portion 421 is adjacent to the installation portion 23 of the casing unit 2, is adjacent to another side of the opening 412, and is spaced apart from the first engagement portion 413 of the muzzle body 41 in the nail-striking direction (X). In this embodiment, the second engagement portion 421 is configured to be a protrusion.

Any one of the magazine unit 5 and the accessory unit 6 is selectable to be removably connected to the muzzle unit 4. In some embodiments, the magazine unit 5 is connected to the muzzle unit 4, while the accessory unit 6 is not connected to the muzzle unit 4. In some embodiments, the accessory unit 6 is connected to the muzzle unit 4, while the magazine unit 5 is not connected to the muzzle unit 4.

The magazine unit 5 includes a magazine 51 and a nail-pushing member 52. The magazine 51 is adapted for receiving a plurality of nails (not shown) therein. The nail-pushing member 52 is movably connected to the magazine 51. When the magazine unit 5 is selected to be connected to the muzzle unit 4, the magazine unit 5 abuts against the installation portion 23 of the casing unit 2, a portion of the magazine 51 extends through the opening 412 and is removably connected to the first engagement portion 413 of the muzzle body 41, and another portion of the magazine 51 is removably connected to the interconnection portion 24 of the casing unit 2. The nail-pushing member 52 is drivable by a resilient force to push the nails toward the nail channel 411 of the muzzle body 41. Consequently, the magazine unit 5 may supply the nails automatically, and may convert the nail gun into a continuous firing mode.

Referring to FIGS. 2, 4 and 6, the accessory unit 6 includes a base seat 61, a movement member 62, a block member 63, a resilient member 64, and a pull member 65.

The base seat 61 has a first end surface 611, a second end surface 612, a passage 613, a first couple portion 614, a block portion 615, a seat surface 616, and a limitation portion 617. The second end surface 612 is opposite to the first end surface 611 along an axis (L). When the accessory unit 6 is connected to the muzzle unit 4, the second end surface 612 faces the second engagement portion 421 of the engagement member 42. The passage 613 extends from the first end surface 611 to the second end surface 612 along the axis (L). The first couple portion 614 is adjacent to the first end surface 611. The block portion 615 is connected to the first couple portion 614, and extends along the axis (L). The seat surface 616 is opposite to the block portion 615 in a direction that is perpendicular to the axis (L). The limitation portion 617 is formed at the seat surface 616 such that the limitation portion 617 is spaced apart from the block portion 615 in the direction perpendicular to the axis (L). In this embodiment, the first couple portion 614 is configured to be a protrusion, and has two curved edges 618 that are spaced apart from each other. In addition, in this embodiment, the block portion 615 has a carrier surface 619 that is opposite to the seat surface 616.

The movement member 62 is connected to the base seat 61. Specifically, the movement member 62 extends through the passage 613, is movable relative to the passage 613 along the axis (L), and has a second couple portion 621 and a projection portion 622. The second couple portion 621 is opposite to the first couple portion 614 of the base seat 61. The block portion 615 of the base seat 61 is located between the first couple portion 614 of the base seat 61 and the second couple portion 621. The projection portion 622 is opposite to the second couple portion 621 along the axis (L), and projects out from the base seat 61. In this embodiment, the second couple portion 621 is configured to be a recess.

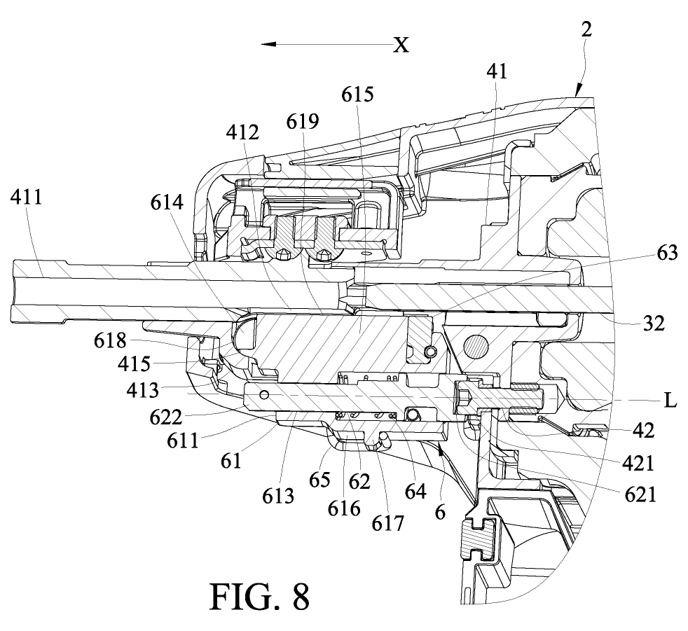

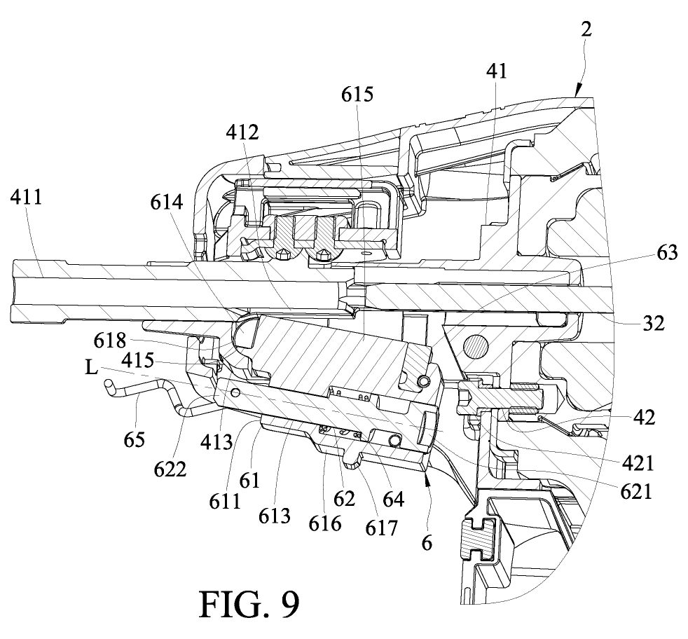

Referring to FIGS. 8 and 9, the movement member 62 is movable relative to the base seat 61 between an engagement position (see FIG. 8) and a released position (see FIG. 9). When the movement member 62 is in the engagement position, the second couple portion 621 of the movement member 62 is distal to the first end surface 611. When the movement member 62 is in the released position, the second couple portion 621 of the movement member 62 is proximate to the first end surface 611.

The block member 63 extends into the base seat 61 in the direction perpendicular to the axis (L).

The resilient member 64 is disposed in the passage 613, has two opposite ends that respectively abut against the base seat 61 and the movement member 62, and resiliently biases the movement member 62 toward the engagement position.

The pull member 65 is connected to the projection portion 622 of the movement member 62, and is operable to urge the movement member 62 to move from the engagement position to the released position. When the movement member 62 is in the engagement position, the pull member 65 is operable to hook the limitation portion 617 of the base seat 61.

Referring to FIGS. 2 and 8, when the accessory unit 6 is connected to the muzzle unit 4, an extending direction of the axis (L) is parallel to the nail-striking direction (X), and the accessory unit 6 is spaced apart from the installation portion 23 of the casing unit 2 in the direction that is perpendicular to the axis (L). When the accessory unit 6 is connected to the muzzle unit 4, the first couple portion 614 of the accessory unit 6 is rotatably and slidably coupled to the curved surface 415 of the first engagement portion 413 of the muzzle unit 4, and the curved edges 618 of the first couple portion 614 are in slidable contact with the curved surface 415. When the accessory unit 6 is connected to the muzzle unit 4, the first couple portion 614 of the base seat 61 and the second couple portion 621 of the movement member 62 are respectively coupled to the first engagement portion 413 of the muzzle body 41 and the second engagement portion 421 of the engagement member 42 so that the accessory unit 6 is prevented from moving in the nail-striking direction (X) by the first engagement portion 413 of the muzzle body 41, and is prevented from moving in the direction perpendicular to the axis (L) by the second engagement portion 421 of the engagement member 42. Consequently, the accessory unit 6 is stably positioned at the muzzle body 41.

When the accessory unit 6 is connected to the muzzle unit 4, the block portion 615 of the base seat 61 extends into the opening 412 so that the opening 412 is not allowed to spatially communicate with the nail channel 411 and the external environment (i.e., the nail channel 411 is prevented from spatially communicating with the external environment through the opening 412). Moreover, the carrier surface 619 of the block portion 615 cooperates with the muzzle unit 4 to define the nail channel 411 so that any one of the nails that is in the nail channel 411 is prevented from entering the opening 412. Consequently, the accessory unit 6 may convert the nail gun into a single firing mode. Every time when one of the nails that is in the nail channel 411 is struck by the strike member 32, a user may load the nail channel 411 with another one of the nails manually.

It is noted that the abovementioned manual-loading operation may also be suitable for a nail that is attached with accessories and that may only be partially accommodated in the nail channel 411, for example, a nail with a wire hook.

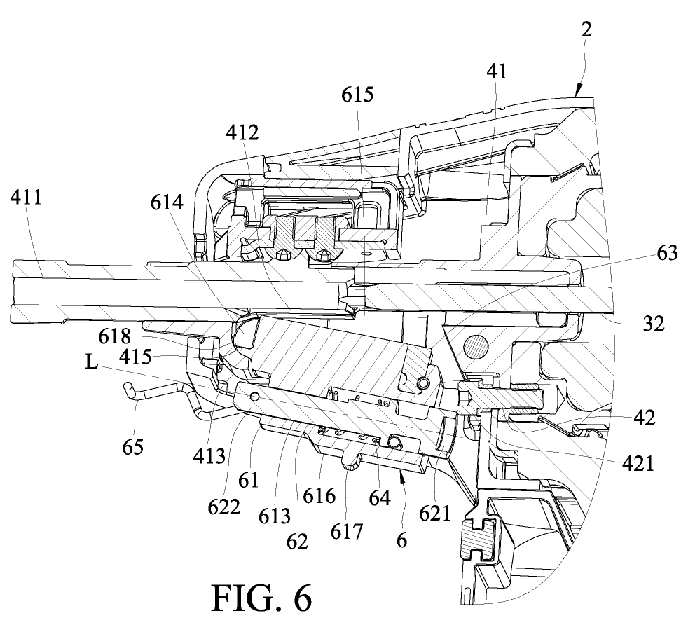

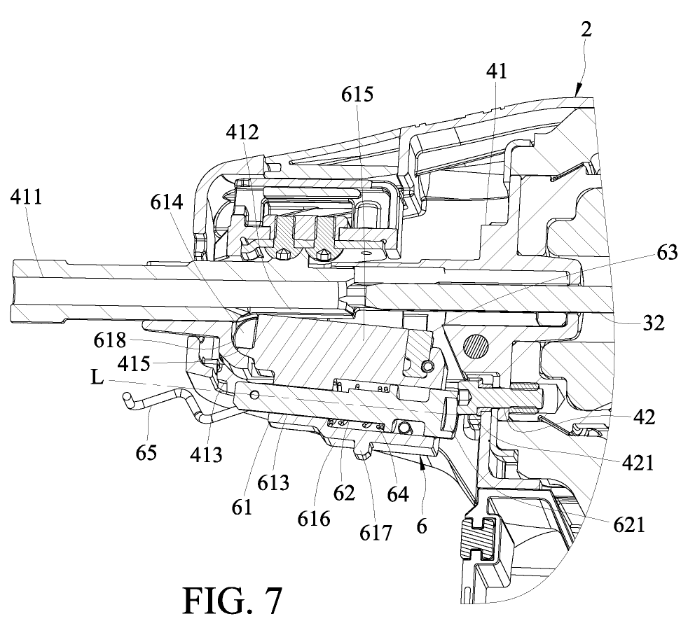

Referring to FIGS. 6 to 8, when assembling the accessory unit 6 and the muzzle unit 4, by virtue of the curved edges 618 of the first couple portion 614 of the base seat 61 being in slidable contact with the curved surface 415 of the first engagement portion 413 of the muzzle unit 4, as long as the first couple portion 614 is coupled to the first engagement portion 413, the movement member 62 may abut against the second engagement portion 421 of the engagement member 42 when the accessory unit 6 is pushed toward the muzzle body 41. When the movement member 62 abuts against the second engagement portion 421 and when the accessory unit 6 is continuously pushed toward the muzzle body 41, the movement member 62 is urged to move away from the engagement member 42 along the axis (L), and compresses the resilient member 64. Afterwards, when the second couple portion 621 of the movement member 62 faces the second engagement portion 421, the movement member 62 is urged to move toward the second engagement portion 421 along the axis (L) by a restoring force that is provided by the resilient member 64 (i.e., the resilient member 64 resiliently biases the movement member 62 toward the engagement position). Consequently, when the accessory unit 6 is connected to the muzzle unit 4 and when the movement member 62 is in the engagement position, the second couple portion 621 of the movement member 62 is coupled to the second engagement portion 421 of the engagement member 42, and the block portion 615 of the base seat 61 extends into the opening 412. Then, when the pull member 65 is operated to hook the limitation portion 617 of the base seat 61, the movement member 62 is prevented from moving so that the accessory unit 6 is stably positioned at the muzzle body 41.

Referring to FIG. 9, when separating the accessory unit 6 from the muzzle body 41, the user may pull the pull member 65 to separate the pull member 65 from the limitation portion 617 of the base seat 61, and then may pull the pull member 65 along the axis (L) to urge the movement member 62 to move away from the engagement member 42 along the axis (L) (i.e., the movement member 62 is urged to move toward the released position), thereby compressing the resilient member 64. When the movement member 62 is in the released position, the second couple portion 621 of the movement member 62 is separated from the second engagement portion 421 of the engagement member 42. When the pull member 65 is continuously pulled, by virtue of the curved edges 618 being in slidable contact with the curved surface 415, the first couple portion 614 of the base seat 61 may serve as a pivot such that the base seat 61 swings away from the muzzle body 41. When the block portion 615 of the base seat 61 is separated from the opening 412, the accessory unit 6 may be separated from the muzzle body 41.

It is noted that the first engagement portion 413 of the muzzle body 41 may not be limited to being a recess, and the second engagement portion 421 of the engagement member 42 may not be limited to being a protrusion. In one modification of the embodiment, the first engagement portion 413 and the second engagement portion 421 may respectively be configured to be a protrusion and a recess, while the first couple portion 614 of the base seat 61 and the second couple portion 621 of the movement member 62 may respectively be configured to be a recess and a protrusion so as to respectively match the first engagement portion 413 and the second engagement portion 421.

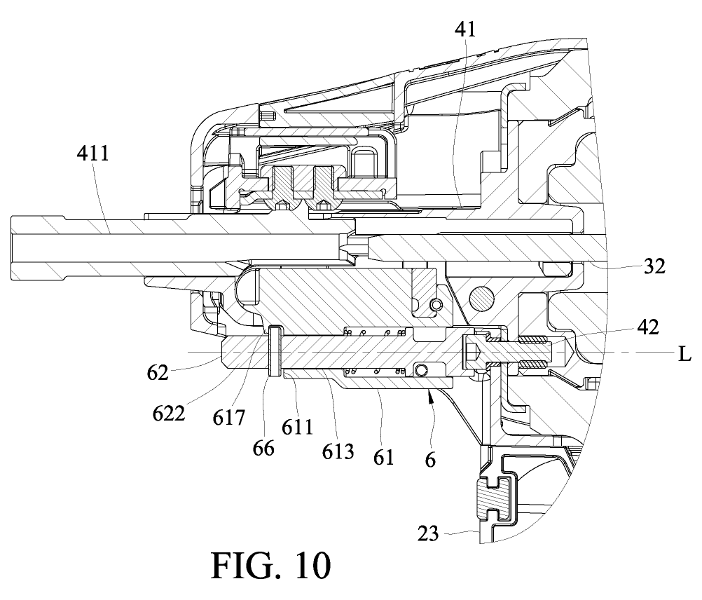

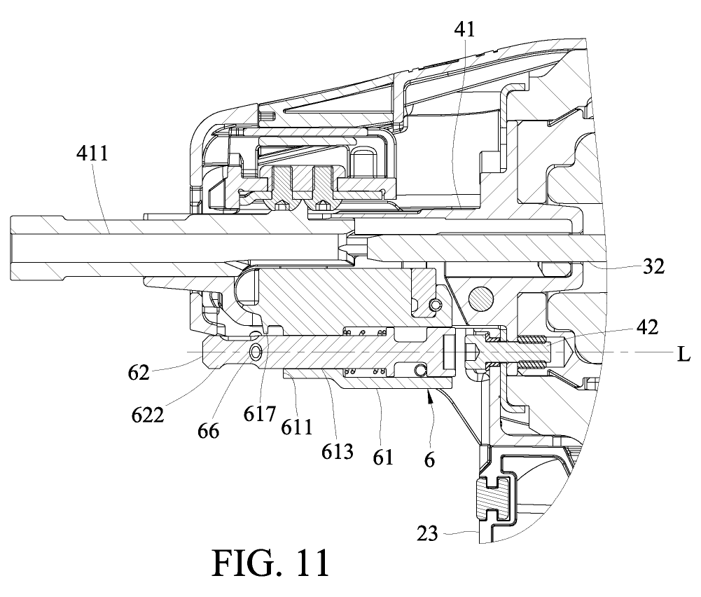

In addition, operating the pull member 65 to hook the limitation portion 617 of the base seat 61 may not be the only means to limit movement of the movement member 62. In one modification of the embodiment, the accessory unit 6 may further include a limitation member 66 as shown in FIGS. 10 and 11.

Referring to FIGS. 10 and 11, the limitation portion 617 of the base seat 61 is spaced apart from the first end surface 611 of the base seat 61 along the axis (L), the movement member 62 extends through the passage 613 and is rotatable relative to the passage 613, and the limitation member 66 extends through the projection portion 622 of the movement member 62 in the direction perpendicular to the axis (L). Therefore, when the movement member 62 is in the engagement position, the limitation member 66 is operable to be blocked by the limitation portion 617 so that the movement member 62 is retained in the engagement position. The movement member 62 is operable to rotate to separate the limitation member 66 from the limitation portion 617. When the limitation member 66 is separated from the limitation portion 617, the projection portion 622 is operable to move such that the movement member 62 is moved from the engagement position to the released position.

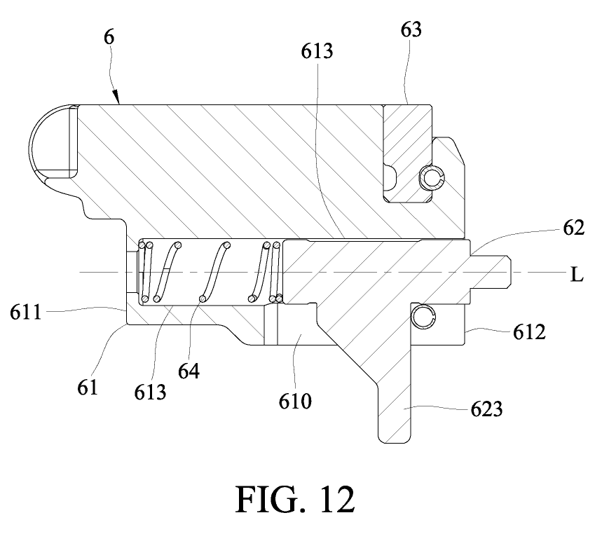

It is noted that operation of the movement member 62 may not be limited to operating the pull member 65 or operating the projection portion 622 of the movement member 62. In one modification of the embodiment as shown in FIG. 12, the base seat 61 further has a slide groove 610 that extends along the axis (L) and that spatially communicates with the passage 613 and the external environment. The movement member 62 further has a press portion 623 that extends through the slide groove 610 in the direction perpendicular to the axis (L). The press portion 623 of the movement member 62 is operable to move such that the movement member 62 is moved from the engagement position to the released position. In the modification as shown in FIG. 12, the slide groove 610 extends along the axis (L) to the second end surface 612. However, in another modification, the slide groove 610 may be spaced apart from the second end surface 612.

According to the descriptions above, advantages of the nail gun according to the present disclosure may be summarized as follows.
1. Because the accessory unit 6 is directly connected to the muzzle body 41, the nail gun may be compact and easy to store, and may be manufactured at a relatively lower cost.
2. The accessory unit 6 matches the opening 412, and the first engagement portion 413 of the muzzle body 41 is suitable for any one of the magazine unit 5 and the accessory unit 6 to be connected thereto. Therefore, by virtue of the engagement member 42, the accessory unit 6 may be stably positioned at the muzzle unit 4 without changing a structural design of the muzzle body 41. The nail gun thus has a relatively simple structure and manufacturing costs thereof may be further reduced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An accessory unit adapted for a nail gun, the accessory unit comprising:
a base seat having a first couple portion and a block portion; and
a movement member extending through the base seat, being movable relative to the base seat along an axis, and having a second couple portion.

2. A nail gun adapted for striking a nail, the nail gun comprising:
a casing unit;
a strike unit mounted to the casing unit, and including a strike member that is movable in a nail-striking direction and that is adapted for striking the nail;
a muzzle unit connected to the strike unit, and having
a nail channel that is adapted for accommodating the nail and that extends in the nail-striking direction,
an opening that spatially communicates with the nail channel and an external environment,
a first engagement portion that is adjacent to one side of the opening, and
a second engagement portion that is adjacent to another side of the opening and that is spaced apart from the first engagement portion in the nail-striking direction; and
the accessory unit as claimed in claim 1, the accessory unit being removably connected to the muzzle unit, the first couple portion of the base seat of the accessory unit being coupled to the first engagement portion when the accessory unit is connected to the muzzle unit, the second couple portion of the movement member of the accessory unit being coupled to the second engagement portion when the accessory unit is connected to the muzzle unit, the second couple portion being opposite to the first couple portion, the block portion of the base seat of the accessory unit extending into the opening when the accessory unit is connected to the muzzle unit, the block portion being located between the first couple portion and the second couple portion.

3. The nail gun as claimed in claim 2, further comprising a magazine unit, the casing unit having a main body portion that extends in the nail-striking direction, a grip portion that is connected to the main body portion, and an installation portion that is connected to the main body portion, and that is spaced apart from the grip portion in the nail-striking direction, any one of the accessory unit and the magazine unit being selectable to be removably connected to the muzzle unit, the accessory unit being spaced apart from the installation portion of the casing unit when the accessory unit is connected to the muzzle unit, the magazine unit abutting against the installation portion of the casing unit when the magazine unit is connected to the muzzle unit.

4. The nail gun as claimed in claim 2, wherein:
the muzzle unit includes a muzzle body and an engagement member that is connected to the muzzle body;
the muzzle body has the nail channel, the opening, and the first engagement portion;
the engagement member has the second engagement portion; and
the movement member is connected to the base seat.

5. The nail gun as claimed in claim 4, wherein one of the first couple portion of the base seat and the first engagement portion of the muzzle body is configured to be a protrusion, and another one of the first couple portion of the base seat and the first engagement portion of the muzzle body is configured to be a recess.

6. The nail gun as claimed in claim 4, wherein one of the second couple portion of the movement member and the second engagement portion of the engagement member is configured to be a protrusion, and another one of the second couple portion of the movement member and the second engagement portion of the engagement member is configured to be a recess.

7. The nail gun as claimed in claim 4, wherein:
the accessory unit further includes a resilient member, the base seat having a first end surface, a second end surface that is opposite to the first end surface along the axis, and a passage that extends from the first end surface to the second end surface along the axis, the second end surface of the base seat facing the second engagement portion of the engagement member when the accessory unit is connected to the muzzle unit, the movement member extending through the passage and being movable along the axis, the movement member being movable relative to the base seat between an engagement position, in which the second couple portion of the movement member is distal to the first end surface, and a released position, in which the second couple portion of the movement member is proximate to the first end surface and is separated from the second engagement portion of the engagement member;
when the accessory unit is connected to the muzzle unit and when the movement member is in the engagement position, the second couple portion of the movement member is coupled to the second engagement portion of the engagement member; and
the resilient member is disposed in the passage, has two opposite ends that respectively abut against the base seat and the movement member, and resiliently biases the movement member toward the engagement position.

8. The nail gun as claimed in claim 7, wherein the accessory unit further includes a pull member, the base seat further having a limitation portion that is spaced apart from the block portion thereof in a direction perpendicular to the axis, the movement member further having a projection portion that is opposite to the second couple portion thereof along the axis, the pull member being connected to the projection portion of the movement member, and being operable to urge the movement member to move from the engagement position to the released position, the pull member being operable to hook the limitation portion of the base seat when the movement member is in the engagement position.

9. The nail gun as claimed in claim 7, wherein:
the accessory unit further includes a limitation member, the base seat further having a limitation portion that is spaced apart from the first end surface thereof along the axis, the movement member extending through the passage, being rotatable relative to the passage, and further having a projection portion that is opposite to the second couple portion thereof, the projection portion being operable to move such that the movement member is moved from the engagement position to the released position, the limitation member extending through the projection portion of the movement member in a direction perpendicular to the axis; and
when the movement member is in the engagement position, the limitation member is operable to be blocked by the limitation portion of the base seat so that the movement member is retained in the engagement position.

10. The nail gun as claimed in claim 7, wherein the base seat further has a slide groove that extends along the axis and that spatially communicates with the passage and the external environment, the movement member further having a press portion that extends through the slide groove in a direction perpendicular to the axis, the press portion of the movement member being operable to move such that the movement member is moved from the engagement position to the released position.

11. The nail gun as claimed in claim 10, wherein the slide groove extends along the axis to the second end surface.

12. The nail gun as claimed in claim 2, wherein the first engagement portion of the muzzle unit has a curved surface, the first couple portion of the accessory unit being rotatably and slidably coupled to the curved surface when the accessory unit is connected to the muzzle unit, and having at least one curved edge that is in contact with the curved surface when the accessory unit is connected to the muzzle unit.

13. The nail gun as claimed in claim 2, wherein the block portion of the accessory unit has a carrier surface, the carrier surface cooperating with the muzzle unit to define the nail channel when the accessory unit is connected to the muzzle unit.
